(19) United States
(12) Patent Application Publication
(10) Pub. No.: US 2024/0225204 A9
(43) Pub. Date: Jul. 11, 2024

(54) Keychain Holder

(71) Applicant: Ryan Langton, Hatfield, PA (US)

(72) Inventor: Ryan Langton, Hatfield, PA (US)

(21) Appl. No.: 18/382,137

(22) Filed: Oct. 20, 2023

Related U.S. Application Data
(60) Provisional application No. 63/418,070, filed on Oct. 21, 2022.

(51) Int. Cl. A44B 15/00; F16M 13/02

(52) U.S. Cl. CPC A44B 15/00; F16M 13/02

(57) ABSTRACT

A keychain holder includes a body having a top end, a bottom end, a front face, and a rear face. The body has a through-opening extending therethrough from the front face to the rear face, such that the through-opening is sized to allow a keychain to be inserted therethrough. The bottom end is threaded to receive a vape battery.

### BACKGROUND OF THE INVENTION

### Field of the Invention

The invention relates to a keychain that is configured to retain a battery for a vaping device.

### Description of the Related Art

“Vaping” is a common alternative to smoking traditional cigarettes. While vaping simulates smoking, vape devices generate an aerosol that looks like water vapor but contains nicotine, flavoring, and other chemicals. The aerosol is inhaled into the lungs where the nicotine and chemicals cross over into the bloodstream. Vape devices are electrically operated and use a battery that can be recharged, such as through a common USB adapter.

It would be beneficial to provide a spare battery for a vape device in the event that a USB cable or electrical supply for recharging is not available.

### SUMMARY OF THE INVENTION

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In one embodiment, the present invention is a keychain holder that includes a body having a top end, a bottom end, a front face, and a rear face. The body has a through-opening extending therethrough from the front face to the rear face, such that the through-opening is sized to allow a keychain to be inserted therethrough. The bottom end is threaded to receive a vape battery.

### BRIEF DESCRIPTION OF THE DRAWINGS

The accompanying drawings, which are incorporated herein and constitute part of this specification, illustrate the presently preferred embodiments of the invention, and, together with the general description given above and the detailed description given below, serve to explain the features of the invention. In the drawings:

FIG. 1 is perspective view of a keychain holder according to an exemplary embodiment of the present invention;

FIG. 2 is a front elevational view of the keychain holder of FIG. 1, the rear elevational view being identical;

FIG. 3 is a left side elevational view of the keychain holder of FIG. 1, the right side elevational view being identical;

FIG. 4 is a bottom plan view of the keychain holder of FIG. 1; and

FIG. 5 is a top plan view of the keychain holder of FIG. 1.

### DETAILED DESCRIPTION

In the drawings, like numerals indicate like elements throughout. Certain terminology is used herein for convenience only and is not to be taken as a limitation on the present invention. The terminology includes the words specifically mentioned, derivatives thereof and words of similar import. The embodiments illustrated below are not intended to be exhaustive or to limit the invention to the precise form disclosed. These embodiments are chosen and described to best explain the principle of the invention and its application and practical use and to enable others skilled in the art to best utilize the invention.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

As used in this application, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

The word “about” is used herein to include a value of +/−10 percent of the numerical value modified by the word “about” and the word “generally” is used herein to mean “without regard to particulars or exceptions.”

Additionally, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Unless explicitly stated otherwise, each numerical value and range should be interpreted as being approximate as if the word “about” or “approximately” preceded the value of the value or range.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present invention.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

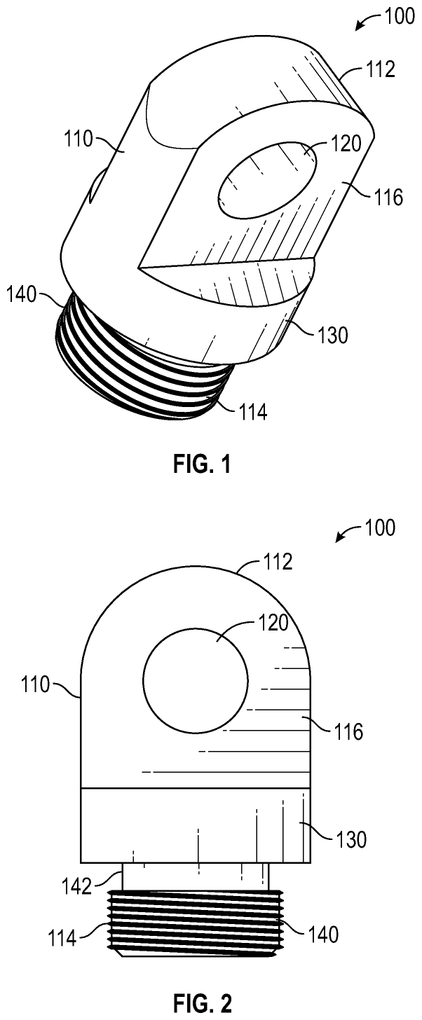

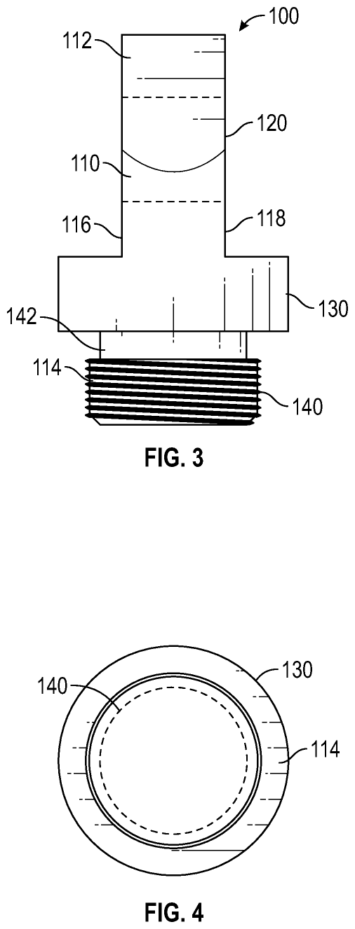

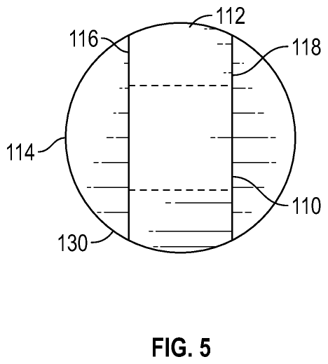

Referring to FIGS. 1-5, a keychain holder 100 (“holder 100”) according to an exemplary embodiment of the present invention is shown. Holder 100 can be used to releasably retain a 510 vape battery (not shown). Holder 100 can be of unitary construction and constructed from a single material, such as aluminum, stainless steel, or other structurally rigid material. Alternatively, holder 100 can be constructed from multiple different materials and/or multiple different pieces and then fixedly attached together to form a single unit.

Holder 100 has a body 110 having a top end 112 and a bottom end 114, as well as a front face 118 and a rear face 120. In an exemplary embodiment, holder 100 can have an overall height of about 0.660 inches. A circular through-opening 120 extends through body 110 from front face 116 to rear face 118, with an exemplary distance between front face 116 and rear face 118 being about 0.17 inches. Through-opening 120 is sized to allow a keychain to be inserted therethrough. In an exemplary embodiment, through-opening 120 can have a radius of about 0.170 inches.

Optionally, top end 112 can have an arcuate profile. In an exemplary embodiment, top end has a radius of about 0.38 inches, or about twice that of the radius of through-opening 120.

Top end 112 is separated from bottom end 114 by a lip 130. In an exemplary embodiment, lip 130 is circular with a radius of about 0.375 inches. Lip 130 provides a feature to separate top end 112, where the keychain will go, from bottom end 114, where the 510 vape battery will attach to holder 100.

Bottom end 114 includes a threaded portion 140. In an exemplary embodiment, threaded portion can be an M7 0.05 right hand thread to mate with the thread on the standard 510 vape battery so that holder 100 can be removably threadably attached to the battery. An offset portion 142, narrower than threaded portion 140 between lip 130 and threaded portion 140 provides for a standoff distance for the battery from lip 130. In an exemplary embodiment, the standoff distance can be about 0.050 inches.

Holder 100 can be attached to a keychain by inserting the keychain through though-opening 120. A 510 vape battery can be threaded onto threaded portion 140, effectively connecting the battery to the keychain so that a user can carry the battery with his/her keys. To use the battery, the user simply unthreads the battery from threaded portion 140.

It will be further understood that various changes in the details, materials, and arrangements of the parts which have been described and illustrated in order to explain the nature of this invention may be made by those skilled in the art without departing from the scope of the invention as expressed in the following claims.

I claim:

1. A keychain holder comprising:
a body having a top end, a bottom end, a front face, and a rear face, the body having a through-opening extending therethrough from the front face to the rear face, such that the through-opening is sized to allow a keychain to be inserted therethrough.

2. The keychain holder according to claim 1, wherein the through-opening has a radius of about 0.170 inches.

3. The keychain holder according to claim 1, wherein the top end has an arcuate profile.

4. The keychain holder according to claim 3, wherein the top end has a radius of about 0.38 inches.

5. The keychain holder according to claim 1, wherein the top end has a radius of about twice that of the radius of the through-opening.

6. The keychain holder according to claim 1, further comprising a lip such that the top end is separated from the bottom end by the

7. The keychain holder according to claim 6, wherein the lip is circular having a radius of about 0.375 inches.

8. The keychain holder according to claim 1, wherein the bottom end includes a threaded portion.

9. The keychain holder according to claim 8, wherein the threaded portion comprises an M7 0.05 right hand thread.

10. The keychain holder according to claim 8, wherein the threaded portion is configured to mate with a mating thread on a vape battery.

11. The keychain holder according to claim 8, further comprising an offset portion between the lip 130 and the threaded portion.

12. The keychain holder according to claim 11, wherein the offset portion is narrower than the threaded portion.
